(19) United States
(12) Patent Application Publication
(10) Pub. No.: US 2011/0053133 A1
(43) Pub. Date: Mar. 3, 2011

(54) SYSTEMS AND METHODS FOR DISCREETLY PROVIDING REAL-TIME FEEDBACK TO AN INSTRUCTOR

(76) Inventors: Marcia L. Rock, Tuscaloosa, AL (US); Beth Thead, Pensacola, FL (US)

(21) Appl. No.: 12/414,413

(22) Filed: Mar. 30, 2009

Related U.S. Application Data
(60) Provisional application No. 61/072,210, filed on Mar. 28, 2008.

(51) Int. Cl. G09B 7/00

(52) U.S. Cl. 434/351

(57) ABSTRACT

The present disclosure generally relates to systems and methods for providing with real-time feedback from one user, referred to herein as an “advisor,” to another. In one exemplary embodiment, a real-time feedback system enables an advisor to remotely monitor an instructor, such as a school teacher, while the instructor is instructing attendees, such as attendees, in a classroom or other setting. While the advisor is monitoring the instructor, the advisor provides real-time feedback that is discreetly communicated to the instructor in an unobtrusive manner that does not significantly disturb the presentation or teaching environment. In this regard, the attendees are unable to hear or see the feedback and may even be unaware that the instructor is receiving feedback from an advisor during the presentation, although it is possible for the attendees to hear and/or see the feedback in other embodiments. The feedback provided to the instructor can be useful for assisting the instructor in various ways, including constructive criticism and suggestions for various teaching techniques.

### CROSS REFERENCE TO RELATED APPLICATION

This application claims priority to U.S. Provisional Patent Application No. 61/072,210, entitled “Systems and Methods for Providing Real-Time Feedback from One User to Another,” and filed on Mar. 28, 2008, which is incorporated herein by reference.

### RELATED ART

It can be desirable to observe school teachers in a classroom setting for a variety of reasons. For example, one may observe a teacher in order to evaluate the performance of the teacher or the teaching techniques employed by the teacher. Further, it may be desirable for a researcher to observe many different teachers in order to ascertain the effectiveness of various teaching techniques. In some cases, the observer may be an experienced educator who not only can observe the teacher but actively provide feedback and suggestions in order to improve the teacher's performance.

Often an observer visits the classroom of a teacher so that the observer can see and hear the instruction provided by the teacher. However, the mere presence of the observer in the classroom can be distracting to the teaching environment and to the teacher. Further, if the observer attempts to provide suggestions to the teacher during the lesson, the students are likely to hear the feedback possibly distracting the students. An observer may wait to the end of class to provide feedback to the teacher, but such feedback may be less effective when delayed. In fact, some feedback, if provided in class, may have the effect of immediately influencing the teacher's instruction in a positive manner during the lesson. Unfortunately, an observer is often faced with deciding between providing helpful feedback to the teacher in the classroom and disrupting the classroom environment. Techniques for enabling the observation of teachers in the classroom and the communication of real-time feedback without significantly disrupting the teaching environment would be generally desirable.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a real-time feedback system.

FIG. 2 is a block diagram illustrating an exemplary embodiment of an instructor station, such as is depicted in FIG. 1.

FIG. 3 is a block diagram illustrating an exemplary embodiment of a base unit, such as is depicted in FIG. 2.

FIG. 4 is a block diagram illustrating an exemplary embodiment of an advisor station, such as is depicted in FIG. 1.

FIG. 5 depicts an exemplary embodiment of a headset, such as is depicted in FIG. 2.

FIG. 6 depicts an exemplary embodiment of a headset, such as is depicted in FIG. 2.

FIG. 7 is a block diagram illustrating an exemplary embodiment of a computer system that implements an advisor station, such as is depicted in FIG. 4.

FIG. 8 is a block diagram illustrating an exemplary embodiment of a computer system that implements an instructor station, such as is depicted in FIG. 2.

FIG. 9 depicts an exemplary embodiment of a graphical user interface for coding an observation and feedback session.

FIG. 10 is a flowchart illustrating an exemplary operation and use of a real-time feedback system, such as is depicted in FIG. 1.

### DETAILED DESCRIPTION

The present disclosure generally relates to systems and methods for providing real-time feedback from one user, referred to herein as an “advisor,” to another. In one exemplary embodiment, a real-time feedback system enables an advisor to remotely monitor an instructor, such as a school teacher, while the instructor is instructing attendees, such as students, in a classroom or other setting. While the advisor is monitoring the instructor, the advisor provides real-time feedback that is discreetly communicated to the instructor in an unobtrusive manner that does not significantly disturb the presentation or teaching environment. In this regard, the attendees are unable to hear or see the feedback and may even be unaware that the instructor is receiving feedback from an advisor during the presentation, although it is possible for the attendees to hear and/or see the feedback in other embodiments. The feedback provided to the instructor can be useful for assisting the instructor in various ways, including constructive criticism and suggestions for various teaching techniques.

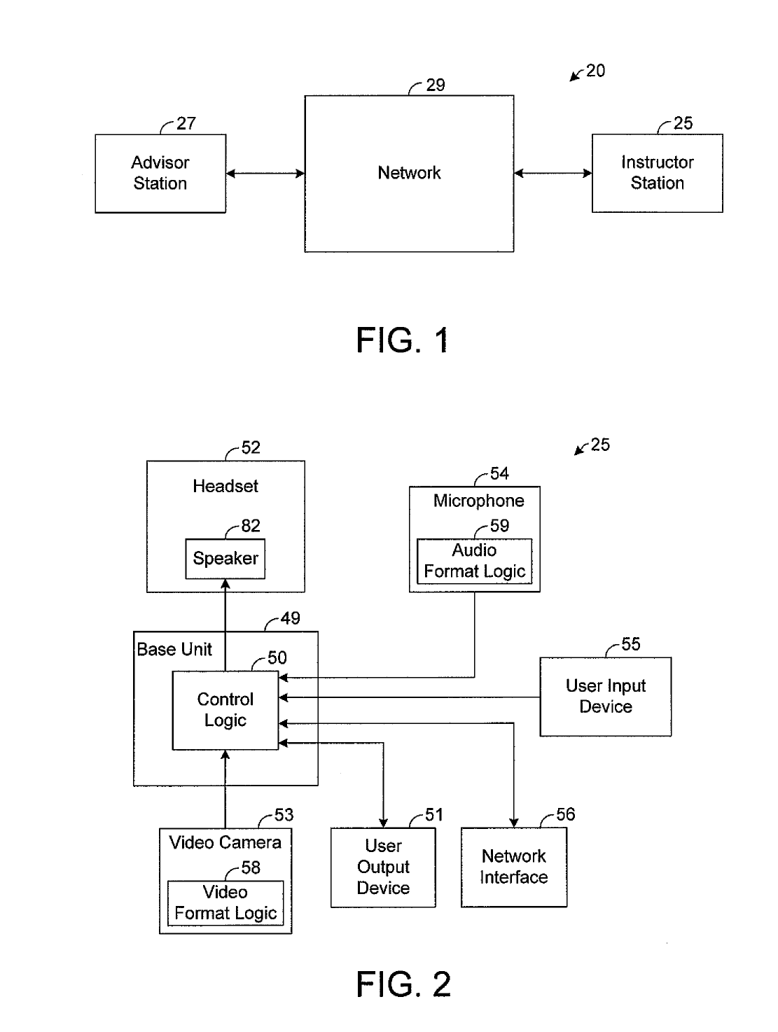

FIG. 1 depicts an exemplary embodiment of a real-time feedback system 20. The system 20 comprises an instructor station 25 that is situated at a premises, such as a school classroom, where an instructor, such as a school teacher, is providing instruction to a group of attendees, such as students. The instructor station 25 communicates with an advisor station 27 via a network 29, such as a wide area network (WAN) (e.g., the Internet) and/or a local area network (LAN), for example. While the instructor is teaching or otherwise presenting, the station 25 captures data (e.g., audio and/or or video data), referred to as “monitoring data,” that can be used to monitor the instruction environment, including the teaching performed by the instructor. For example, the monitoring data may include audio data defining the sounds (e.g., words spoken by the instructor and/or attendees) in the classroom and/or video data defining images, such as images of the instructor and/or attendees.

The instructor station 25 transmits the monitoring data through the network 29 to the advisor station 27, which renders the monitoring data to the advisor. For example, the advisor station 27 may display video images of the classroom environment and/or regenerate the sounds sensed by the instructor station 25. In this regard, the words spoken by the instructor may be sensed by the instructor station 25 and played by the advisor station 27 so that the advisor at the station 27 hears, in real-time, the words spoken by the instructor. Moreover, the advisor is able to observe visually and/or audibly the instructor, as well as other aspects of the instruction environment, such as questions asked by attendees or other attendee behavior.

Based on the advisor's observations of the instructor and/or the instruction environment, the advisor provides real-time feedback to assist the instructor in teaching the attendees and/or refining his or her teaching or presentation techniques. Such feedback can be in a variety of forms, such as visual or audio. For example, the advisor may speak instructions or recommendations into a microphone that records the advisor's speech. In another example, the advisor may type a text message or other type of visual message. Data, referred to herein as “feedback data,” defining the feedback provided by the advisor is transmitted through the network 29 to the instructor station 25, which renders the feedback data to the instructor. For example, for audio feedback data, the instructor station 25 may comprise a speaker for playing such audio data so that the instructor can hear verbal instructions or recommendations provided by the advisor. For visual data, the instructor station 25 may comprise a display device for displaying visual instructions or recommendations provided by the advisor.

In one exemplary embodiment, the feedback data is rendered to the instructor in real-time such that the instructor receives the feedback defined by such data while he or she is teaching or otherwise presenting. Accordingly, the feedback is likely to be more effective and useful than in an embodiment in which the feedback is delayed, such as after the teaching session has concluded.

Note that by using a network 29 for communicating between the instructor station 25 and the advisor station 27, it is unnecessary for the advisor to be at the same location as the instructor in order to observe him or her and provide feedback. For example, the instructor station 25 may be located in a classroom where the instructor is teaching, and the advisor station may be located in another area, such as another classroom or another building, of the same school. It is also possible for the advisor to be located outside of the school entirely, such as in another city, state, or country. Moreover, the advisor can observe the instructor and provide real-time feedback regardless of the advisor's physical proximity relative to the instructor.

FIG. 2 depicts an exemplary embodiment of the instructor station 25. The instructor station 25 shown by FIG. 2 has base unit 49 in which control logic 50 resides for generally controlling the operation of the station 25, as will be described in more detail hereafter.

It should be noted that the control logic 50 can be implemented in software, hardware, firmware, or any combination thereof. If any portion of the control logic 50 is implemented in software or firmware, then such software or firmware can be stored on any computer-readable medium for use by or in connection with an instruction execution apparatus that can fetch and execute instructions. In the context of this document, a “computer-readable medium” can be any means that can store a program for use by or in connection with an instruction execution apparatus.

As shown by FIG. 2, the control logic 50 is coupled to and communicates with a user output device 51, a headset 52, a video camera 53, a microphone 54, and a user input device 55. The user output device, such as a display device (e.g., a liquid crystal display (LCD)) or printer, allows a user to receive outputs from the control logic 50, and the user input device 55, such as a keyboard or mouse, allows a user to provide inputs to the control logic 50. The microphone 54 detects sounds, such as the instructor speaking, and converts such sounds into audio data 53. In FIG. 2, the microphone 54 is shown as being separate from the headset 52 and the video camera 53. However, in other embodiments, the microphone 54 may be incorporated into the headset 52 or the video camera 53, if desired.

The video camera 53 generates video data defining images viewed by the camera 53, such as images of the instructor and/or attendees. In one exemplary embodiment, the video camera 53 is implemented via a webcam, which is configured to package the video data in a format for transfer over the Internet. For example, the video camera 53 may be integrated with video format logic 58 that is configured to packetize the video data according to transmission control protocol/Internet protocol (TCP/IP) for transmission. However, other types of video cameras are possible. For example, a digital video camera may be used, and the control logic 50 may comprise video format logic 58 that receives the digital data and packetizes the digital data for transmission. Alternatively, the video format logic 58 could be external from the video camera 53 and run separately from the control logic 50. The video format logic 58 is generally configured to format the video data based on the type of network 29 over which the video data is to be transmitted, and any type of desirable protocol for the network transmission is possible.

Similarly, audio format logic 59 may be used to appropriately format audio data detected by the microphone 54 in order to transmit such audio data via the network 29. In one exemplary embodiment, the audio format logic 59 uses a protocol, such as TCP/IP, compatible with the Internet. Further, the audio format logic 59 may be integrated with the microphone 54 or stored external to the microphone 54.

The control logic 50 is configured to receive the video data and the audio data from the video camera 53 and the microphone 52, respectively, and to transmit such data, referred to as “monitoring data,” through the network 29 via a network interface 56 to the advisor station 27. If desired, the control logic 50 may be configured to reformat the data before transfer. Various types of interface devices may be used to implement the network interface 56. For example, the network interface 56 may comprise a digital subscriber line (DSL) modem or cable modem, although other types of interface devices may be used in other embodiments. In addition, if desired, any of the devices 51-55 may communicate data with the control logic 50 via wireless signals so that it is unnecessary for such devices 51-55 to be physically coupled to the control logic 50.

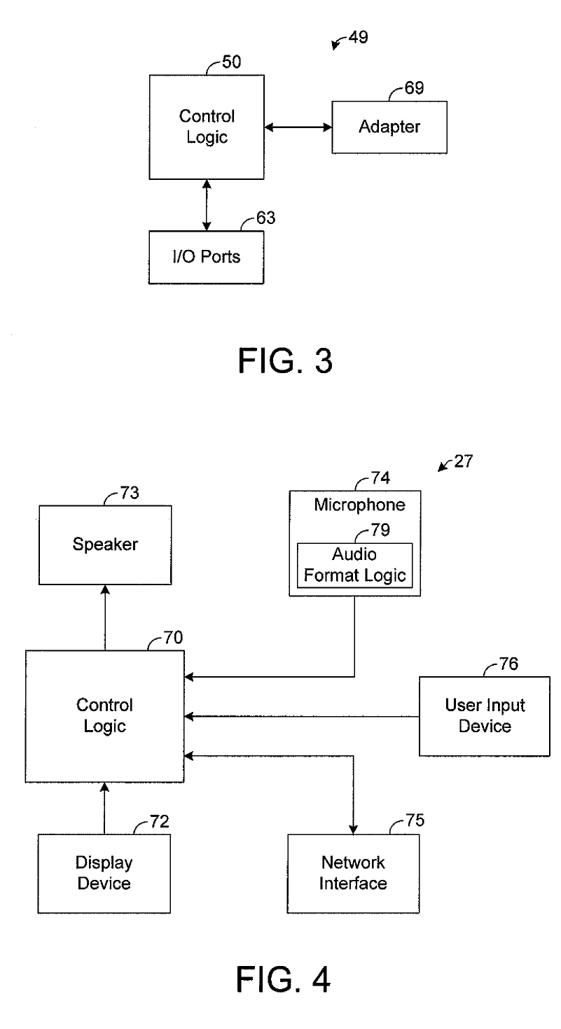

As shown by FIG. 3, the base unit 49 has a plurality of input/output (I/O) ports 63 and an adapter 69. The I/O ports 63 are interfaced with components that are physically coupled to the base unit 49, and the adapter 69 wirelessly communicates with one or more components. For example, in one exemplary embodiment, the user output device 51, the video camera 53, the user input device 55, and the network interface 56 are coupled to the I/O ports 63 via physical media, such as cables, and the speaker and microphone 54 communicate wirelessly with the adapter 69. For example, the base unit 49 may be implemented as a computer, such as a desk-top, lap-top, or hand-held computer, that communicates with the microphone 54 and/or speaker 82 via Bluetooth protocols. In other embodiments, other configurations are possible. Indeed, it is possible for any of the components 51-56 to communicate with the control logic 50 via wireless signals or to be coupled to the I/O ports 63 via physical media.

FIG. 4 depicts an exemplary embodiment of the advisor station 27. The advisor station 27 shown by FIG. 4 has control logic 70 for generally controlling the operation of the station 27, as will be described in more detail hereafter. It should be noted that the control logic 70 can be implemented in software, hardware, firmware, or any combination thereof. If any portion of the control logic 70 is implemented in software or firmware, then such software or firmware can be stored on any computer-readable medium for use by or in connection with an instruction execution apparatus that can fetch and execute instructions.

As shown by FIG. 4, the control logic 70 is coupled to and communicates with a display device 72, a speaker 73, a microphone 74, a network interface 75, and a user input device 76, such as a keyboard or mouse. If desired, any of the components 72-76 may communicate wireless signals with the control logic 70. In one exemplary embodiment, the advisor station 27 is implemented via a computer, such as a desk-top, lap-top, or hand-held computer. For example, the control logic 70 may be implemented in software and stored within a computer. However, other configurations of the advisor station 27 are possible in other embodiments.

The control logic 70 is configured to display, via the display device 72, the video data received from the instructor station 25. In addition, the control logic 70 is configured to play, via the speaker 73, the audio data received from the instructor station 25. By viewing the display device 72 and/or listening to the sounds produced by the speaker 73, the advisor is able to observe the instructor and/or the instruction environment at the instructor station 25 in real-time as the instructor is teaching or otherwise presenting.

The microphone 74 detects sounds, such as the advisor speaking, and converts such sounds into audio data. For example, the advisor may verbally provide a teaching or suggestion for the instructor based on the advisor's observations of the instructor. The microphone 74 detects the advisor's speech and converts such speech into audio data. The control logic 70 then transmits the audio data, referred to as “feedback data,” through the network 29 to the instructor station 25. In this regard, as shown by FIG. 4, the advisor station 27 comprises audio format logic 79 that is configured to convert audio data provided by the microphone 74 into a format compatible with the network 29. In one exemplary embodiment, the audio format logic 79 is configured to packetize the audio data in accordance with TCP/IP, but other protocols are possible in other embodiments. Further, like the audio format logic 59 of FIG. 2, the audio format logic 79 of FIG. 4 may be implemented in hardware, software, firmware, or any combination thereof, and the audio format logic 79 may be integral with the microphone 74 or external to it.

Upon receiving the audio feedback data, the control logic 50 (FIG. 2) of the instructor station 25 plays such data via the speaker 82. Thus, the instructor hears the suggestion or other comment spoken by the advisor. In one exemplary embodiment, the speaker 82 is incorporated into the headset 52, which is worn by the instructor, so that the suggestion is only heard by the instructor thereby reducing the obtrusiveness of the suggestion to the instruction environment. In this regard, the attendees may be unable to hear the suggestion and be unaware that the instructor even received the suggestion.

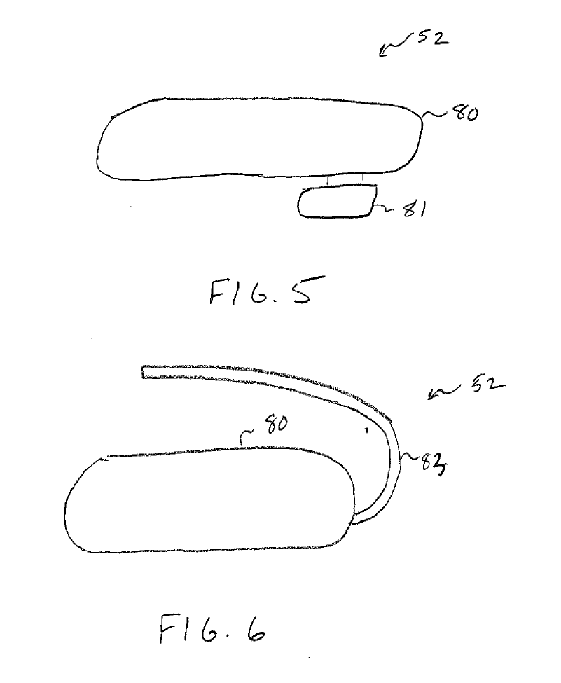

FIGS. 5 and 6 depict exemplary embodiments of a headset 52. In FIG. 5, the headset 52 has a base 80 and an ear insertion element 81. The ear insertion element 81 is dimensioned to fit snugly inside of the ear canal of a user. The instructor inserts the element 81 into his or her ear canal such that friction between the element 81 and the instructor's ear canal holds the headset 52 in place. The headset 52 of FIG. 6 has a curved arm 83 that fits around the ear of the instructor in order to hold the headset 52 in place. The headsets 52 shown by FIGS. 5 and 6 are generally well-known and commonly employed to implement Bluetooth protocols for cellular devices. Other types of headsets 52 may be used in other embodiments.

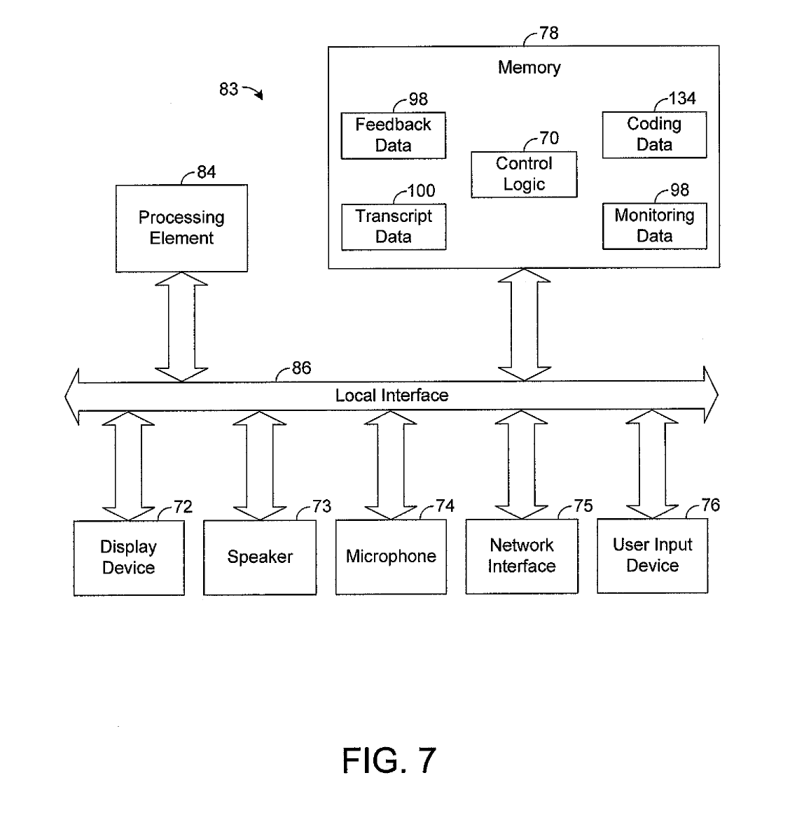

FIG. 7 depicts an exemplary embodiment in which the control logic 70 of the advisor station 27 is implemented in software and stored within memory 78 of a computer system 83. The exemplary embodiment of the computer system 83 depicted by FIG. 7 comprises at least one conventional processing element 84, such as a central processing unit (CPU), that communicates to and drives the other elements within the computer system 83 via a local interface 86, which can include at least one bus. As an example, if any portion of the control logic 70 is implemented in software, the processing element 84 may be configured to execute instructions of such software.

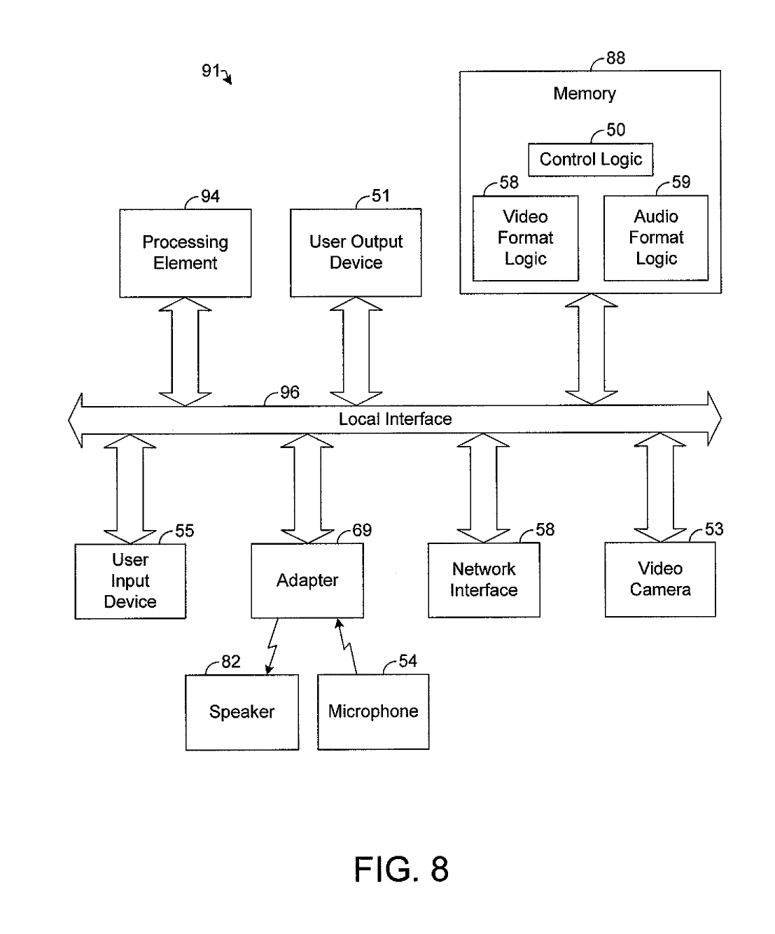

FIG. 8 depicts an exemplary embodiment in which the control logic 50 of the instructor station 25 is implemented in software and stored within memory 88 of a computer system 91. In the exemplary embodiment shown by FIG. 8, the video format logic 58 and the audio format logic 59 are also implemented in software and stored in memory 88. However, in other embodiments, any of the logic 50, 58, and 59 can be implemented in hardware, firmware, software, or any combination thereof. Further, it is unnecessary for the logic 50, 58, and 59 to be stored in the same memory device. For example, as described above, it is possible for the control logic 50 to be external to the microphone 54 and the video camera 58 but for the video format logic 58 and the audio format logic 59 to be integrated with the video camera 53 and the microphone 54, respectively.

The exemplary embodiment of the computer system 91 depicted by FIG. 8 comprises at least one conventional processing element 94, such as a central processing unit (CPU), that communicates to and drives the other elements within the computer 91 via a local interface 96, which can include at least one bus. As an example, if any of the logic 50, 58, and 59 is implemented in software, the processing element 94 may be configured to execute instructions of such software.

In one exemplary embodiment, the computer system 91 comprises an adapter 69 that is configured to wirelessly communicate with the speaker 82 and/or microphone 54. For example, radio frequency signals may be communicated between the adapter 69 and the speaker 82 and/or microphone 54. In one exemplary embodiment, the adapter 69 is configured to communicate with the speaker 82 and the microphone 54 via Bluetooth protocols, but other types of protocols are possible in other embodiments.

The video format logic 58 receives video data captured by the video camera 53 and packetizes such data in accordance with TCP/IP for transmission through the Internet. Such data is received by the advisor station 27, and the display device 72 (FIG. 4) displays the video data. In addition, the audio format logic 59 receives audio data captured by the microphone 54 and packetizes such data in accordance with TCP/IP and/or voice over Internet protocol (VoIP) for transmission through the network Internet. Such data is received by the advisor station 27, and the speaker 73 plays the audio data. Based on the output of the display device 72 and the speaker 73, the advisor observes the instructor at the station 25 in real-time as the instructor is teaching.

Any suggestion or other comment by the advisor is sensed via the microphone 75 and converted into audio data. The audio format logic 79 is configured to packetize such data, and the control logic 70 is configured to transmit the audio data through the Internet to the instructor station 25 using TCP/IP and/or voice over Internet protocol (VoIP). For example, in one exemplary embodiment, the control logic 70 and/or audio format logic 79 utilize Skype, which is an Internet-based application for formatting voice data in accordance with IP for transmission over the Internet. In other embodiments, other applications and/or techniques for formatting the audio data from the microphone 75 in accordance with IP or other protocols are possible.

The foregoing audio data, when received at the instructor station 25, is transmitted to the speaker 82 via adapter 69. The speaker 82 plays the audio data such that the instructor can hear the suggestion or other comment uttered by the advisor. Accordingly, the instructor receives real-time feedback from the advisor.

It should be emphasized that various types of feedback may be provided to the instructor. For example, as described above, it is possible for verbal comments by the advisor to be detected and sent to the instructor in real-time. However, in other embodiments, it is possible for the advisor to define a text message via input device 72 or otherwise and to transmit the text message to the instructor in real-time. In such an embodiment, the instructor station 25 preferably comprises a display device (not specifically shown) to enable the instructor to see the text message. As a mere example, the display device may be a computer monitor or teleprompter.

In addition, in one exemplary embodiment, the advisor station 27 stores various types of graphical data that could be selected by the advisor for transmission to the instructor station 25 for rendering to the instructor. As an example, data defining graphs or charts may be transmitted to the instructor station 25 and displayed to the instructor. In another example, a video clip is stored at the advisor station 27 and transmitted to the instructor station 25, which plays the video clip to the instructor. As a mere example, data representing a recording of an experienced instructor elaborating on a particular point may be stored at the advisor station 27. Such data could be transmitted to the instructor station 25 and rendered in order to illustrate a particular teaching technique or suggestion to the instructor. Moreover, various other types of predefined video clips or other visual content may be accessible to the advisor and included in the feedback provided to the instructor.

In one exemplary embodiment, the instructor station 25 comprises a cellular telephone. In this regard, a conventional cellular telephone can be used to display text messages from the advisor to the instructor. Also, a Bluetooth or other type of headset may be used in conjunction with a cellular telephone so that verbal comments from the advisor are conveyed to the instructor. For example, the advisor may call the instructor's cell phone via a cellular network to establish a cellular channel through which the advisor can send feedback to the instructor. Various other types of modifications to the exemplary embodiments specifically described herein would be apparent to one of ordinary skill in the art upon reading this disclosure.

In one exemplary embodiment, the control logic 70 of the advisor station 27 is configured to store feedback data 98 and/or monitoring data 99 for archival purposes, as shown by FIG. 7. This data 98 and 99 may also be used for coding. In this regard, coding generally refers to an evaluation process for evaluating the instructor's and/or advisor's performance. For example, a researcher may use the archived data to determine the number of times and/or frequency that the advisor provided feedback to the instructor, and the number of times and/or the frequency that the instructor responded to the feedback (e.g., followed a suggestion by the advisor). In another example, a researcher may use the archived data to determine statistics about the instructor's performance, such as the number of times that an attendee asked a question. Various other types of statistics may be employed to quantify the effectiveness of the system 20, advisor, instructor, or other aspects of the monitoring or teaching process.

It is also possible for the control logic 70 to assist in coding. For example, in one exemplary embodiment, the advisor station 27 stores templates of coding forms that may be used to gather various statistics, such as some of the exemplary statistics described above. As the advisor is observing the instructor, the advisor may update the form as appropriate such that coding is performed simultaneously with the instructor observation. In addition, the control logic 70 may be configured to automate at least a portion of the coding. For example, the control logic 70 may be configured to automatically track the timing or frequency of various events, such as when the advisor offers feedback and/or when the instructor follows a suggestion proffered by the advisor.

In this regard, in one exemplary embodiment, the control logic 70 displays a graphical user interface (GUI) having a button, icon, or some other graphical element, referred to hereafter as the “feedback element,” that the advisor selects when he or she provides feedback. The GUI may also have a button, icon, or some other graphical element, referred to hereafter as the “response element,” that the advisor selects when the instructor responds to the advisor's feedback (e.g., follows a suggestion proffered by the advisor). Each time the advisor selects either the feedback or response element, the control logic 50 stores an indication of such event. As an example, the control logic 50 may add or update an entry in a database. Such entry may indicate which element was selected by the advisor and the time of selection. Based on such data stored by the control logic 50, the control logic 50 generates and/or outputs various statistics. For example, the control logic 50 can calculate the frequency of feedback occurrences and the frequency of response occurrences. Further, the control logic 50 can calculate the percentage of feedback occurrences that resulted in a response by the instructor. Various other types of statistics can be determined by the control logic 50 and output (e.g., printed or otherwise displayed) to a user. Accordingly, although additional coding may be later performed, coding is effectively performed by the advisor and/or control logic 70 while the advisor is observing and providing feedback to the instructor in real-time. The coding data generated from such coding is referred to as being in “real-time.”

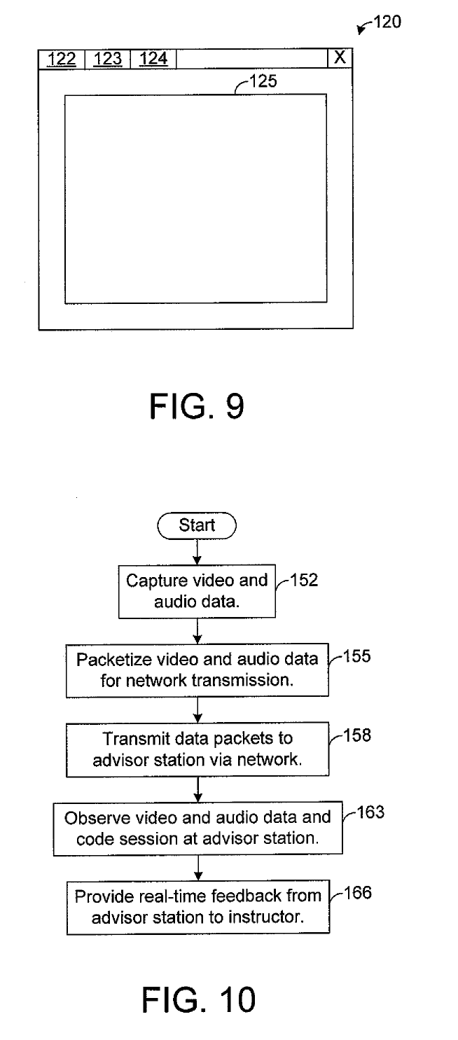

To better illustrate the foregoing, refer to FIG. 9 which depicts an exemplary GUI 120 having three graphical buttons 122-124 that can be selected by the advisor. Also, within the GUI 120 is a sub-window 125 in which the vide data captured by the video camera 53 at the instructor station 25 is displayed. The advisor selects one button 122, referred to as the “feedback button,” each time the advisor provides feedback to the instructor, and the advisor selects another button 123, referred to as the “response button,” each time the instructor responds to the advisor's feedback in a noticeable manner. Also, the advisor selects the button 124, referred to as “event button,” each time the advisor observes a particular event occurring at the instructor station 25. As an example, the particular event may be an attendee asking a question, the instructor admonishing an attendee, or some other event that the advisor desires to track. The control logic 70 is configured to count the number of times that each button 122-124 is selected during an observation and feedback session and to store the counts for future use. For example, based on inputs from the advisor or otherwise, the control logic 70 may display the counts or calculate various statistics based on the counts. The data generated by the coding is referred to as the “coding data 131” and is stored by the control logic 70 in the memory 78, as shown by FIG. 7.

In other embodiments, other techniques for coding the observation and feedback session are possible. For example, rather than selecting a graphical element to indicate the occurrence of a coded event, such as the occurrence of a feedback, a response, or a question by an attendee, as described above, the advisor could select a hardware element, such as a key of a keyboard. Thus, the control logic 70 counts the number to times that a particular key is pressed. Alternatively, the advisor could manually count the coded events and enter the count via the user input device 76.

Note that it is unnecessary for the advisor to mark the events indicated by the coding data 131 that is maintained by the control logic 70. For example, the control logic 70 may be configured to automatically sense a feedback occurrence by analyzing the feedback data 98. In this regard, the control logic 70 may be configured to determine when the advisor is speaking based on the feedback data 98 and to automatically count feedback occurrences accordingly. For example, a time period of speaking between two time periods of silence for a predefined duration may be automatically identified as an occurrence of a feedback.

The coding data 131 stored by the control logic 70 may include various types of information, such as the counts or other statistics observed during the observation and feedback session. In addition, the coding data 131 may include notes entered by the advisor via the user input device 76 or otherwise. Each record included in the coding data 131 is preferably time-stamped so that the record can be verified at a later time, and the start of the observation and feedback session is also time-stamped to serve as a point of reference for the time-stamped events. For example, when the advisor observes an event and selects one of the buttons 122-124, the control logic 70 records the time of the button selection. Thus, the video defined by the monitoring data 99 can be viewed at a later time, and the point in the video at which the button was selected can be determined based on the timestamp correlated with the record. A decision can then be made whether the advisor's interpretation of the event was correct.

In another embodiment, the advisor manually determines various statistics about the session. For example, the advisor may manually count the number of times that particular events occur during the session and then enter the coding data 131 at the end of the session.

The coding data 131, feedback data 98, and/or monitoring data 99 may be stored by the control logic 70 to provide a historical record of the monitoring and feedback session between an advisor and an instructor. For example, such data may be stored in a database or other type of memory. Further, to facilitate lookup of the data, the stored data may be correlated with various keys that can be searched to find the data for a desired session. As a mere example, for each observation and feedback session, the name or other identifier of the advisor, the name or other identifier of the instructor, and/or the date or time of the session may be stored along with the session's feedback, monitoring, and/or coding data as a lookup key for such data. In this regard, prior to the start of the observation and feedback session or at some other time period, the control logic 70 may prompt the advisor for lookup keys and other information about the session. Utilizing the lookup keys, a database storing the data for many sessions can be quickly searched to find the data 98, 99, and 131 correlated with a particular advisor or instructor. For example, the coding data 131 for many different sessions involving a particular instructor or advisor can be quickly located by searching the lookup keys for the name or other identifier of the instructor or advisor. In addition, the control logic 70 may be configured to automatically find coding data 131 for many different sessions of the same advisor or instructor and to combine such coding data 131 into a single set of data indicative of the overall performance of the advisor or instructor for all such sessions. Many other techniques for manipulating the coding data 131 and generating various statistics based on the coding data 131 would be apparent to one of ordinary skill in the art upon reading this disclosure. In addition, the coding data 131 for each session is correlated with the session's feedback data 98 and monitoring data 99 so that all of the data for a particular session can be quickly located.

In addition, it is possible for the control logic 70 to automatically generate transcripts of the speech defined by the audio data received from the instructor station 25. In this regard, in one exemplary embodiment, the control logic 70 comprises conventional speech recognition logic (e.g., software) that is configured to analyze audio data received by the station 25 and convert the speech defined by such data into text to provide a transcript of the observation and feedback session. The transcript may include the comments defined by the audio data from the instructor station 27 and/or the audio data from the microphone 74 at the advisor station 25. Thus, the transcript may include the speech of the instructor, the advisor, or both. Transcript data 100 (FIG. 7) defining the converted speech is stored in memory 78 and may be later analyzed or displayed for various purposes. In one exemplary embodiment, the transcript data 100 is stored in a file that is correlated with the coding data 131, the feedback data 98, and the monitoring data 99 of the same session.

In this regard, the control logic 70 is configured to store all of the data pertaining to a session in a database or other type of memory system. Further, the feedback data 98, the monitoring data 99, the transcript data 100, and the coding data 131 of the same session are correlated such that all such data can be located via a single search of the memory system. For example, as described above, the advisor may enter various key words, such as the name of the instructor, name of the advisor, and/or date of the observation and feedback session, that are correlated with the session's data in memory. Thus, by searching the key words associated with a particular session, the session's feedback data 98, monitoring data 99, transcript data 100, coding data 131, and other data associated with the session can be located and retrieved.

In one exemplary embodiment, the conversion of speech data into text is automatically performed as the audio data defining the speech is received by the control logic 70 during the observation and feedback session. Thus, at the conclusion of the observation and feedback session, the transcript data 100 is available for review or further processing.

Indeed, at the conclusion of the observation and feedback session, the session's feedback data 98, monitoring data 99, transcript data 100, coding data 131, and other data associated with the session are available for use by the advisor or other user. If desired, the control logic 70 can be configured to display, print, or otherwise report various portions of the session's data and statistics of interest to the advisor. For example, the control logic 70 may report selected parameters of the coding data 131.

Moreover, the feedback system 20 allows for static and separate scientific procedures to be performed in a dynamic and simultaneous manner, thereby resulting in substantive savings of not only time, but also labor. In the past, many such scientific research procedures were performed separately and sometimes manually. For example, to collect important information about teaching and learning, an educational researcher often traveled to differing classroom sites to observe and to video record the day-to-day classroom experience. Then, the researcher coded and transcribed the videotaped classroom data. The educational researcher then entered the coded data into a qualitative and/or quantitative software program where it was analyzed and summarized. Finally, if the educational researcher wished to compare his or her results with other data, then another series of steps were performed, such as accessing the desired database, downloading data, entering and analyzing comparative data into a quantitative or qualitative software program, and so forth. Taken together these scientifically sound procedures take weeks, months, and sometimes years to complete.

By contrast, the feedback system 20 allows the educational researcher to electronically capture the classroom observation in real-time from remote sites. As described previously, while carrying out the session, the advisor can enter codes, which can be immediately analyzed and summarized, using quantitative and qualitative methods. Such data can be viewed as is or can be compared immediately and/or automatically, if desired, to other educational data (e.g., discipline, attendance, academic achievement), such as local (e.g., district), state (e.g., State Department of Education), or national (e.g., Institute of Education Sciences) data using a database interface or otherwise. For example, the control logic 70 may be configured to access data from sources other than the observation and feedback session (e.g., data from other studies and/or sessions) and automatically compare such data with the coding data 131 or other data from the observation and feedback session. The summarized and/or compared data (reported either in separate or interfaced form) can then be printed for immediate review and discussion. In this way, the feedback system 20 not only allows for intensive analysis of individual classroom units, but also for the efficient undertaking of large scale comparison studies. Note that the control logic 70 could be configured to automatically provide the summarization, comparison, and/or reporting of data automatically upon the conclusion of the session or some other event. For example, the control logic 70 could be configured to automatically provide the summarization, comparison, and/or reporting in response to an input indicating that the session is concluded. Such input may be input by the advisor or received from the instructor session 25. In other examples, the control logic 70 could automatically initiate the summarization, comparison, and/or reporting in response to other events.

For example, at the classroom level, the advisor could enter a 1 each time the teacher posed a higher order thinking question and a 2 for each lower level question. Such input is stored as part of the coding data 131. Then, the advisor could run a descriptive analysis or qualitative theme summary of the questioning tactics used during the session and print it immediately, following the session, for review. Such data would allow the teacher not only to examine closely the types of questioning tactics used, but also which students were answering the various kinds of questions. Together, the teacher and advisor can make instructional and behavioral decisions based on sound data, rather than biased personal opinion.

To move from micro to macro level analysis, the educational researcher could compare the student, teacher, and classroom specific performance data (e.g., question and answer data) obtained during the session with same data collected from remote sites that differ geographically—either across the district, the state, the nation, or the globe. Then, compare this larger data set with local, state, national, and/or international discipline, attendance, and/or academic achievement data. Doing so would allow for broader, more generalizable trends to emerge thereby informing the professional literature and field of practice with greater efficiency and objectivity.

As described above, the system 20 can be used to provide feedback to a school teacher. However, it should be noted that the system 20 may be used in areas other than education. Indeed, the system 20 can be used in any situation in which it is desirable for an advisor or other type of user to offer feedback to any user of the station 25. The system 20 is particularly effective when the advisor is located remotely from the user that is to receive feedback and when it is desirable to provide feedback discreetly so that others interacting with or listening to the user do not hear the feedback and/or are unaware that the feedback is being given. For example, the system 20 may be used to provide coaching to an inexperienced attorney while conducting a deposition. In this regard, an experienced attorney at a remote location may use the system 20 to observe and provide feedback to the inexperienced attorney while he or she is deposing a witness. The system 20 may also be used in a business meeting to provide coaching to a person giving a presentation. In another example, the system 20 could be used in medicine to provide real-time feedback to a nurse in training who is learning to minimize medical errors by not inadvertently contaminating the sterile field. The data obtained through her coaching session could be used, not only to reduce her future medical errors, but also to compare her performance with other nurses in training. These novice nursing data could, in turn, be compared immediately to expert nursing data; and, both could be correlated with patient outcomes. Again, this illustration captures the innovation offered by the system 20, which allows for training and research procedures to occur seamlessly in real-time, rather than awkwardly after-the-fact. The end result of which is more accurate interpretation of data and, ultimately, more objective decision-making. It should be noted that there are many other situations not specifically described herein in which it may be desirable to employ the real-time feedback systems 20 described herein.

In some applications, it may be desirable to keep the identities of the instructor and attendees private. In one exemplary embodiment, the control logic 70 is configured to edit the monitoring data 99 in an effort to obscure the identities of the instructor and/or attendees. For example, in one exemplary embodiment, the control logic 70 employs a facial recognition algorithm in order to automatically detect faces in the frames of video images received from the instructor station 25. For each detected face, the control logic 70 is configured to blur the facial image thereby making it more difficult to identify the instructor and attendees by viewing the modified video data.

In addition, in one exemplary embodiment, the video camera 53 at the instructor station 25 can be controlled by the advisor. In this regard, the advisor can provide control inputs for controlling the video camera 53, such as zooming the lens of the camera 53 or turning the camera 53. Control information from such inputs is transmitted to the instructor station 25 via the network 29 and is used by the control logic 50 to manipulate the video camera 53 in a desired manner.

An exemplary operation and use of the real-time feedback system 20 will now be described below with reference to FIG. 10. For purposes of illustration, assume that the instructor is a school teacher who is teaching students in a classroom of a school.

Prior to the observation and feedback session, the teacher configures the instructor station 25 in his or her classroom. For example, the teacher may download the control logic 50 into a computer system 91 in his or her classroom and couple the computer system 91 to the video camera 53, user input device 55, and network interface 56. The teacher positions the video camera 53 such that it will view the teacher while he or she is teaching. The teacher also positions the speaker 82 such that he or she can hear sounds produced by the speaker 82. For example, the teacher may don a headset 52 that has the speaker 82. The teacher may also separately couple the microphone 54 to the computer system 91 if the headset 52 does not incorporate a microphone 54.

As the teacher is teaching, the video camera 53 (FIG. 2) captures images of at least the teacher and provides video data defining such images, as shown by block 152 of FIG. 10. In addition, the microphone 54 records at least the speech of the teacher and provides audio data defining such speech, as shown by block 152. The video format logic 58 packetizes the video data for transmission through the network 29, and the audio format logic 59 packetizes the audio data for transmission through the network 29, as shown by block 155 of FIG. 10. The control logic 50 of the instructor station 25 transmits the data packets containing the video and audio data through the network 29 to the advisor station 27, as shown by block 158 of FIG. 10.

The control logic 70 of the advisor station 27 depacketizes the data packets and displays the video data via the display device 72 and renders the audio data via the speaker 73. Thus, at a remote location, the advisor observes the teacher in real-time as the teacher is instructing the students, as shown by block 163 of FIG. 10. Also, if desired, the advisor may perform coding in real-time to generate real-time coding data, as described above, in real-time.

At some point during the observation, the advisor may have feedback for the teacher. For example, as the teacher is instructing the students on the history of a particular war, the advisor may verbally suggest that the teacher show on a map the locations of various countries that participated in the war. The microphone 74 of the advisor station 27 converts the verbal suggestion into audio data, referred to as “feedback data,” and the audio format logic 79 packetizes such data for transmission through the network 29. The control logic 70 then transmits the feedback data through the network 29 to the instructor station 25 via a plurality of data packets. The control logic 50 of the instructor station 25 depacketizes such data packets to recover the feedback data, and then wirelessly transmits the feedback data via the adapter 69 to the speaker 82. The speaker 82 plays the message defined by the feedback data such that the teacher hears the advisor's suggestion without the students hearing such suggestion, as shown by block 166 of FIG. 10. In response, the teacher may go to a map in the classroom and point out the countries involved in the war being described.

Accordingly, the advisor is able to view the teacher's lesson in real-time and provide real-time feedback to the teacher without distracting the students. In addition, by utilizing a network, it is unnecessary for the advisor to be in the classroom in order to observe the teacher. In fact, by using a wide area network, it is possible for the advisor to be located many miles away. Therefore, it is possible for the advisor to observe and provide real-time feedback to many different teachers without having to travel to many different locations, thereby saving the advisor significant time and costs. In addition, the system 20 allows and facilitates coding in real-time so that at least some coding is completed at the conclusion of the observation and feedback session thereby providing additional efficiency benefits to the advisor.

Now, therefore, the following is claimed:

1. A system for discreetly providing real-time feedback to an instructor, comprising:
a headset having a first speaker;
a video camera configured to capture video images of the instructor while the instructor is providing instruction to a group of attendees thereby providing video data indicative of the captured video images;
a first microphone configured to convert speech of the instructor into audio data;
a network interface coupled to a network; and
first logic configured to transmit data packets defining the video data and the audio data to the network interface such that the data packets are transmitted to an advisor station via the network thereby enabling an advisor at the advisor station to view the video images and hear the speech, the first logic configured to receive feedback data from the advisor station and to wirelessly transmit the feedback data to the first speaker, wherein the first speaker is configured to generate sound based on the feedback data such that the instructor hears a real-time feedback message defined by the feedback data without the attendees hearing the feedback message.

2. The system of claim 1, wherein the network comprises the Internet.

3. The system of claim 1, wherein the advisor station comprises:
a display device;
a speaker;
a second microphone; and
second logic configured to display the video images in real-time via the display device and to play the speech via the second speaker, the second logic configured to receive the feedback message via the second microphone.

4. The system of claim 3, wherein the advisor station comprises a user input interface, wherein the second logic is configured to generate real-time coding data as the video images are displayed in real-time, wherein the second logic is configured to store the video data and the coding data, and wherein the second logic is configured to correlate the coding data with the video data.

5. The system of claim 4, wherein the second logic is configured to automatically convert the audio data into text as the audio data is received by the second logic from the network, and wherein the second logic is configured to correlate the text with the coding data and the video data.

6. The system of claim 4, wherein the second logic is configured to display a graphical user interface (GUI) having a user-selectable graphical element, wherein the coding data is based on the graphical element.

7. The system of claim 6, wherein the graphical element comprises a button.

8. The system of claim 6, wherein the second logic is configured to count selections of the graphical element, and wherein the coding data is based on a count of the selections of the graphical element.

9. The system of claim 6, wherein the second logic is configured to display the video data within the GUI.

10. A method for discreetly providing real-time feedback to an instructor, comprising the steps of:
providing video data defining images of an instructor while the instructor is providing instruction to a group of attendees at a first location;
providing audio data defining speech of the instructor while the instructor is providing the instruction to the group of attendees;
packetizing the video and the audio data thereby defining a plurality of data packets;
transmitting the data packets via a network to a remote location;
receiving the data packets from the network;
displaying the images of the instructor at the remote location in real-time via the video data based on the data packets received from the network;
generating the speech of the instructor at the remote location in real-time via the audio data based on the data packets received from the network;
receiving feedback in real-time from an advisor viewing the displayed images at the remote location;
defining feedback data based on the feedback;
transmitting the feedback data to a base unit at the first location;
wirelessly transmitting the feedback data from the base unit to a headset worn by the instructor; and
generating sound based on the feedback data such that the instructor hears a real-time feedback message defined by the feedback data without the attendees hearing the feedback message.

11. The method of claim 10, wherein the instructor is a school teacher, wherein the attendees are students of the school teacher, and wherein the first location is a school at which the school teacher in instructing the students.

12. The method of claim 11, wherein the network comprises the Internet.

13. The method of claim 10, further comprising the steps of:
generating real-time coding data based on the displaying step;
storing the video data and the coding data; and
correlating the coding data with the video data.

14. The method of claim 13, further comprising the step of automatically converting the audio data into text at the remote location as the audio data is received from the network.

15. The method of claim 13, further comprising the step of displaying a graphical user interface (GUI) at the remote location concurrently with the displaying the images step, the GUI having a user-selectable graphical element, wherein the coding step is based on the graphical element.

16. The method of claim 15, wherein the graphical element comprises a button.

17. The method of claim 15, further comprising the step of counting selection of the graphical element, wherein the coding data is based on the counting step.

18. The method of claim 15, wherein the displaying the images step comprises the step of displaying the images within the GUI.
